(19) United States
(12) Patent Application Publication
(10) Pub. No.: US 2026/0281851 A1
(43) Pub. Date: Sep. 17, 2026

(54) METHOD AND APPARATUS FOR APPLYING TRP SWITCHING

(71) Applicants: HYUNDAI MOTOR COMPANY, Seoul (KR); Kia Corporation, Seoul (KR)

(72) Inventors: Jeong Su Lee, Hwaseong-si, Gyeonggi-do (KR); Ui Hyun Hong, Hwaseong-si, Gyeonggi-do (KR); Young Kil Suh, Hwaseong-si, Gyeonggi-do (KR); Gene Back Hahn, Hwaseong-si, Gyeonggi-do (KR)

(73) Assignees: HYUNDAI MOTOR COMPANY, Seoul (KR); Kia Corporation, Seoul (KR)

(21) Appl. No.: 19/471,320

(22) PCT Filed: May 8, 2024
(86) PCT No.: PCT/KR2024/006128

§ 371 Date: Sep. 30, 2025

(30) Foreign Application Priority Data
May 12, 2023 (KR) 10-2023-0062006

(51) Int. Cl. H04W 36/08; H04B 7/06; H04W 36/24

(52) U.S. Cl. CPC H04W 36/08; H04B 7/06968; H04W 36/249

(57) ABSTRACT

Disclosed are a method and an apparatus for applying TRP switching. A method of a UE comprises the steps of: performing first TRP communication with a base station; receiving a first indication of a TRP switching operation from the base station; determining an application time of the TRP switching operation on the basis of the first indication; performing the TRP switching operation from the first TRP communication to second TRP communication at the application time; and performing the second TRP communication with the base station.

### TECHNICAL FIELD

The present disclosure relates to an enhanced communication technique, and more particularly, to a technique for applying transmission and reception point (TRP) switching in a communication system.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, multiple transmission and reception points (mTRP) may be introduced into a communication network (e.g., 5G communication network and/or 6G communication network). The mTRP may be geographically separated. A base station may perform communication with a terminal using the mTRP. mTRP technology may be used to solve a quality of service (QoS) degradation problem of a cell-edge terminal and/or an inter-cell interference problem. In an environment where a non-line-of-sight (NLOS) path is limited, the mTRP technology may be used to provide an additional communication path.

mTRP-based communication may be performed based on a coherent joint transmission (CJT) scheme or a non-CJT (NCJT) scheme. In the CJT scheme, the mTRP may perform cooperative communication based on a stable backhaul link, and the mTRP may provide synchronized communication services to the terminal. In the NCJT scheme, the mTRP may provide communication services to the terminal without cooperation. For example, in the NCJT scheme, the mTRP may perform operations such as scheduling operations, precoding matrix selection operations, and modulation and coding scheme (MCS) determination operations without cooperation.

In the communication network, a TRP switching operation between mTRP communication and single-TRP (sTRP) communication may be required. The TRP switching operation may refer to a switching operation from mTRP communication to sTRP communication and/or a switching operation from sTRP communication to mTRP communication. A signaling method for the TRP switching operation may be required. When a TRP switching operation is indicated, an application time of the TRP switching operation needs to be clearly defined.

### DISCLOSURE

### Technical Problem

The present disclosure is directed to providing a method and an apparatus for applying a switching operation between a single TRP and multiple TRPs in a communication system.

### Technical Solution

A method of a user equipment (UE), according to exemplary embodiments of the present disclosure for achieving the above-described objective, may comprise: performing a first transmission and reception point (TRP) communication with a base station; receiving a first indication of a TRP switching operation from the base station; determining an application time of the TRP switching operation based on the first indication; performing the TRP switching operation from the first TRP communication to a second TRP communication at the application time; and performing the second TRP communication with the base station, wherein when the first TRP communication is multiple-TRP (mTRP) communication, the second TRP communication is single-TRP (sTRP) communication, and when the first TRP communication is sTRP communication, the second TRP communication is mTRP communication.

The method may further comprise receiving information on a TRP switching gap from the base station, wherein the application time is after the TRP switching gap from a reception time of the first indication.

The application time may be after the UE transmits a response to the first indication to the base station.

The second TRP communication after performing the TRP switching operation may be performed until reception of a second indication of a TRP switching operation or a transmission configuration indicator (TCI) state update indication.

The method may further comprise receiving information on a TRP switching duration from the base station, wherein the second TRP communication after performing the TRP switching operation is performed during the TRP switching duration.

The method may further comprise receiving repetition configuration information for the TRP switching operation from the base station, wherein the second TRP communication after performing the TRP switching operation is performed during a repetition duration indicated by the repetition configuration information.

The method may further comprise: receiving a TCI state update indication from the base station; and updating TCI state(s) for one or more TRPs performing the second TRP communication, wherein TCI state(s) for remaining TRPs among a plurality of TRPs performing the first TRP communication, except the one or more TRPs, are not updated.

The method may further comprise receiving TCI state information from the base station, wherein the application time is after a beam application time for the TCI state information.

A method of a base station, according to exemplary embodiments of the present disclosure for achieving the above-described objective, may comprise: performing a first transmission and reception point (TRP) communication with a user equipment (UE); transmitting a first indication of a TRP switching operation to the UE; determining an application time of the TRP switching operation based on the first indication; performing the TRP switching operation from the first TRP communication to a second TRP communication at the application time; and performing the second TRP communication with the UE, wherein when the first TRP communication is multiple-TRP (mTRP) communication, the second TRP communication is single-TRP (sTRP) communication, and when the first TRP communication is sTRP communication, the second TRP communication is mTRP communication.

The method may further comprise transmitting information on a TRP switching gap to the UE, wherein the application time is after the TRP switching gap from a transmission time of the first indication.

The application time may be after the base station receives a response to the first indication from the UE.

The second TRP communication after performing the TRP switching operation may be performed until transmission of a second indication of a TRP switching operation or a transmission configuration indicator (TCI) state update indication.

The method may further comprise transmitting information on a TRP switching duration to the UE, wherein the second TRP communication after performing the TRP switching operation is performed during the TRP switching duration.

The method may further comprise transmitting repetition configuration information for the TRP switching operation to the UE, wherein the second TRP communication after performing the TRP switching operation is performed during a repetition duration indicated by the repetition configuration information.

The method may further comprise transmitting TCI state information to the UE, wherein the application time is after a beam application time for the TCI state information.

A user equipment (UE), according to exemplary embodiments of the present disclosure for achieving the above-described objective, may comprise at least one processor, wherein the at least one processor may cause the UE to perform: performing a first transmission and reception point (TRP) communication with a base station; receiving a first indication of a TRP switching operation from the base station; determining an application time of the TRP switching operation based on the first indication; performing the TRP switching operation from the first TRP communication to a second TRP communication at the application time; and performing the second TRP communication with the base station, wherein when the first TRP communication is multiple-TRP (mTRP) communication, the second TRP communication is single-TRP (sTRP) communication, and when the first TRP communication is sTRP communication, the second TRP communication is mTRP communication.

The at least one processor may cause the UE to perform: receiving information on a TRP switching gap from the base station, wherein the application time is after the TRP switching gap from a reception time of the first indication.

The second TRP communication after performing the TRP switching operation may be performed until reception of a second indication of a TRP switching operation or a transmission configuration indicator (TCI) state update indication.

The at least one processor may further cause the UE to perform: receiving information on a TRP switching duration from the base station, wherein the second TRP communication after performing the TRP switching operation is performed during the TRP switching duration.

The at least one processor may further cause the UE to perform: receiving repetition configuration information for the TRP switching operation from the base station, wherein the second TRP communication after performing the TRP switching operation is performed during a repetition duration indicated by the repetition configuration information.

### Advantageous Effects

According to the present disclosure, a base station and/or a terminal can switch TRP communication based on an indication of a TRP switching operation. In this case, mTRP communication may be switched to sTRP communication. Alternatively, sTRP communication may be switched to mTRP communication. An application time of the TRP switching operation may be determined based on a preconfigured rule. In other words, the application time of the TRP switching operation may be predefined between the base station and the terminal. The base station and/or the terminal can perform the TRP switching operation at the application time. Therefore, a problem of ambiguity regarding the application time of the TRP switching operation at the base station and/or the terminal can be resolved.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of communication nodes performing communication.

FIG. 4A is a block diagram illustrating a first exemplary embodiment of a transmission path.

FIG. 4B is a block diagram illustrating a first exemplary embodiment of a reception path.

FIG. 5 is a conceptual diagram illustrating a first exemplary embodiment of a system frame in a communication system.

FIG. 6 is a conceptual diagram illustrating a first exemplary embodiment of a subframe in a communication system.

FIG. 7 is a conceptual diagram illustrating a first exemplary embodiment of a slot in a communication system.

FIG. 8 is a conceptual diagram illustrating a first exemplary embodiment of a time-frequency resource in a communication system.

FIG. 9A is a timing diagram illustrating an application time of a TRP switching operation.

FIG. 9B is a timing diagram illustrating an application time of a TRP switching operation.

FIG. 10 is a timing diagram illustrating exemplary embodiments of a communication method based on Type 1 of TRP switching operation.

FIG. 11 is a timing diagram illustrating exemplary embodiments of a communication method based on Type 2 of TRP switching operation.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. In other words, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission and reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

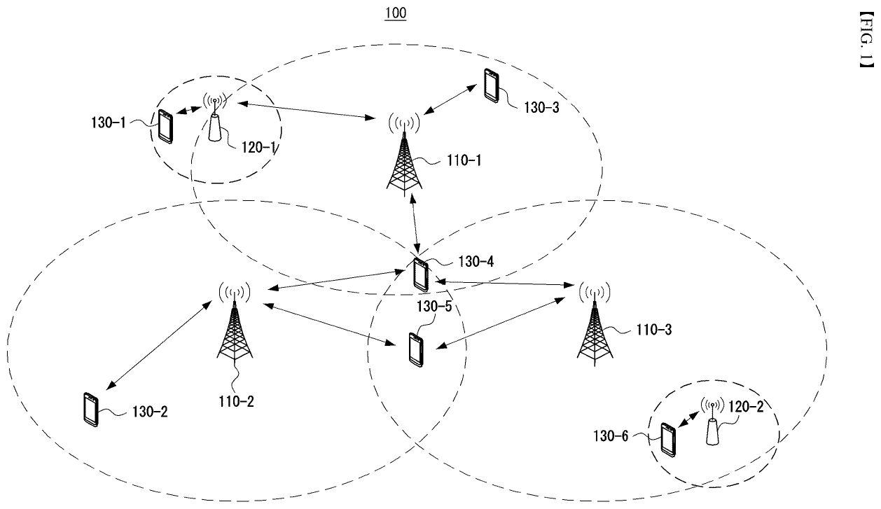

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g., a serving gateway (S-GW), a packet data network (PDN) gateway (P-GW), a mobility management entity (MME). When the communication system 100 is a 5G communication (e.g., NR system), the core network may include an access and mobility management function (AMF), a user plane function (UPF), a session management function (SMF), and the like.

The plurality of communication nodes 110 to 130 may support communication protocols (e.g., LTE communication protocol, LTE-A communication protocol, NR communication protocol, etc.) specified in 3^{rd} generation partnership project (3GPP) standards. The plurality of communication nodes 110 to 130 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

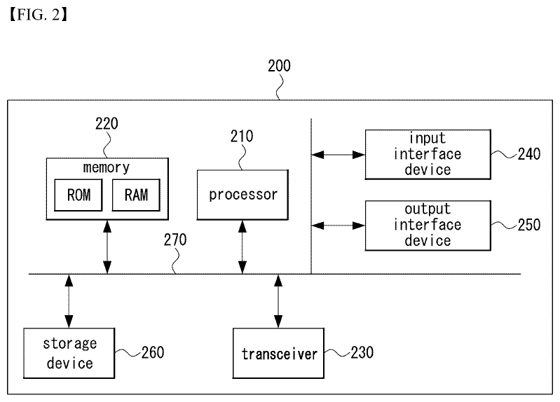

FIG. 2 is a block diagram illustrating a first exemplary embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (COMP) transmission, carrier aggregation (CA) transmission, transmission in an unlicensed band, sidelink communication (e.g., device-to-device (D2D) communication, proximity services (ProSe)), Internet of Things (IoT) communication, dual connectivity (DC), and/or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control sidelink communications between the fourth terminal 130-4 and the fifth terminal 130-5, and thus the fourth terminal 130-4 and the fifth terminal 130-5 may perform the sidelink communications under control of the second base station 110-2 and the third base station 110-3, respectively.

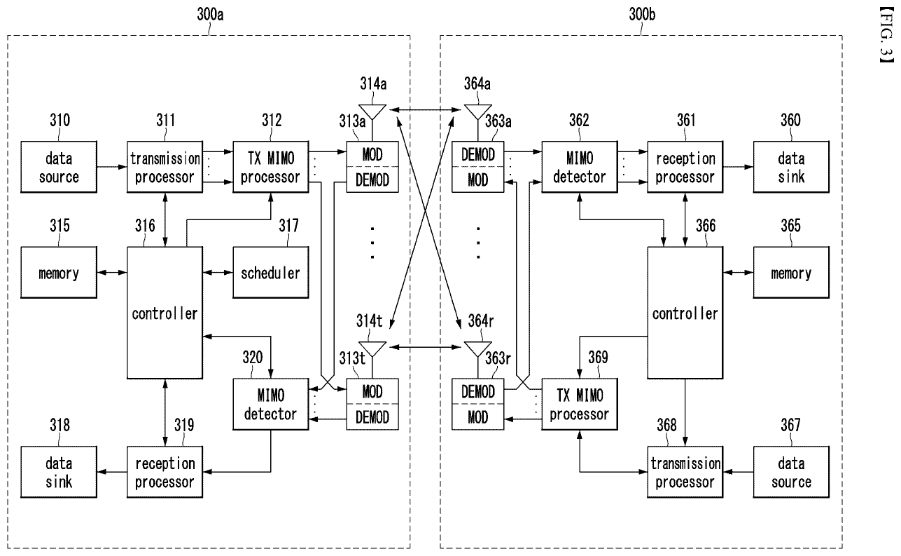

Meanwhile, communication nodes that perform communications in the communication network may be configured as follows. A communication node shown in FIG. 3 may be a specific exemplary embodiment of the communication node shown in FIG. 2.

FIG. 3 is a block diagram illustrating a first exemplary embodiment of communication nodes performing communication.

As shown in FIG. 3, each of a first communication node 300a and a second communication node 300b may be a base station or UE. The first communication node 300a may transmit a signal to the second communication node 300b. A transmission processor 311 included in the first communication node 300a may receive data (e.g., data unit) from a data source 310. The transmission processor 311 may receive control information from a controller 316. The control information may include at least one of system information, RRC configuration information (e.g., information configured by RRC signaling), MAC control information (e.g., MAC CE), or PHY control information (e.g., DCI, SCI).

The transmission processor 311 may generate data symbol(s) by performing processing operations (e.g., encoding operation, symbol mapping operation, etc.) on the data. The transmission processor 311 may generate control symbol(s) by performing processing operations (e.g., encoding operation, symbol mapping operation, etc.) on the control information. In addition, the transmission processor 311 may generate synchronization/reference symbol(s) for synchronization signals and/or reference signals.

A Tx MIMO processor 312 may perform spatial processing operations (e.g., precoding operations) on the data symbol(s), control symbol(s), and/or synchronization/reference symbol(s). An output (e.g., symbol stream) of the Tx MIMO processor 312 may be provided to modulators (MODs) included in transceivers 313a to 313t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 313a to 313t may be transmitted through antennas 314a to 314t.

The signals transmitted by the first communication node 300a may be received at antennas 364a to 364r of the second communication node 300b. The signals received at the antennas 364a to 364r may be provided to demodulators (DEMODs) included in transceivers 363a to 363r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 362 may perform MIMO detection operations on the symbols. A reception processor 361 may perform processing operations (e.g., de-interleaving operation, decoding operation, etc.) on the symbols. An output of the reception processor 361 may be provided to a data sink 360 and a controller 366. For example, the data may be provided to the data sink 360 and the control information may be provided to the controller 366.

On the other hand, the second communication node 300b may transmit signals to the first communication node 300a. A transmission processor 368 included in the second communication node 300b may receive data (e.g., data unit) from a data source 367 and perform processing operations on the data to generate data symbol(s). The transmission processor 368 may receive control information from the controller 366 and perform processing operations on the control information to generate control symbol(s). In addition, the transmission processor 368 may generate reference symbol(s) by performing processing operations on reference signals.

A Tx MIMO processor 369 may perform spatial processing operations (e.g., precoding operations) on the data symbol(s), control symbol(s), and/or reference symbol(s). An output (e.g., symbol stream) of the Tx MIMO processor 369 may be provided to modulators (MODs) included in the transceivers 363a to 363t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 363a to 363t may be transmitted through the antennas 364a to 364t.

The signals transmitted by the second communication node 300b may be received at the antennas 314a to 314r of the first communication node 300a. The signals received at the antennas 314a to 314r may be provided to demodulators (DEMODs) included in the transceivers 313a to 313r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 320 may perform a MIMO detection operation on the symbols. The reception processor 319 may perform processing operations (e.g., de-interleaving operation, decoding operation, etc.) on the symbols. An output of the reception processor 319 may be provided to a data sink 318 and the controller 316. For example, the data may be provided to the data sink 318 and the control information may be provided to the controller 316.

Memories 315 and 365 may store the data, control information, and/or program codes. A scheduler 317 may perform scheduling operations for communication. The processors 311, 312, 319, 361, 368, and 369 and the controllers 316 and 366 shown in FIG. 3 may be the processor 210 shown in FIG. 2, and may be used to perform methods described in the present disclosure.

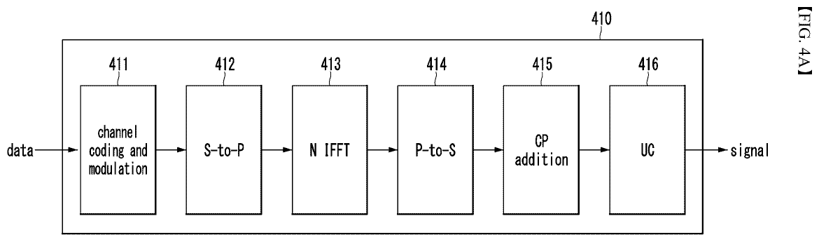

FIG. 4A is a block diagram illustrating a first exemplary embodiment of a transmission path, and FIG. 4B is a block diagram illustrating a first exemplary embodiment of a reception path.

As shown in FIGS. 4A and 4B, a transmission path 410 may be implemented in a communication node that transmits signals, and a reception path 420 may be implemented in a communication node that receives signals. The transmission path 410 may include a channel coding and modulation block 411, a serial-to-parallel (S-to-P) block 412, an N-point inverse fast Fourier transform (N-point IFFT) block 413, a parallel-to-serial (P-to-S) block 414, a cyclic prefix (CP) addition block 415, and up-converter (UC) 416. The reception path 420 may include a down-converter (DC) 421, a CP removal block 422, an S-to-P block 423, an N-point FFT block 424, a P-to-S block 425, and a channel decoding and demodulation block 426. Here, N may be a natural number.

In the transmission path 410, information bits may be input to the channel coding and modulation block 411. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 411 may be a sequence of modulation symbols.

The S-to-P block 412 may convert frequency domain modulation symbols into parallel symbol streams to generate N parallel symbol streams. N may be the IFFT size or the FFT size. The N-point IFFT block 413 may generate time domain signals by performing an IFFT operation on the N parallel symbol streams. The P-to-S block 414 may convert the output (e.g., parallel signals) of the N-point IFFT block 413 to serial signals to generate the serial signals.

The CP addition block 415 may insert a CP into the signals. The UC 416 may up-convert a frequency of the output of the CP addition block 415 to a radio frequency (RF) frequency. Further, the output of the CP addition block 415 may be filtered in baseband before the up-conversion.

The signal transmitted from the transmission path 410 may be input to the reception path 420. Operations in the reception path 420 may be reverse operations for the operations in the transmission path 410. The DC 421 may down-convert a frequency of the received signals to a baseband frequency. The CP removal block 422 may remove a CP from the signals. The output of the CP removal block 422 may be serial signals. The S-to-P block 423 may convert the serial signals into parallel signals. The N-point FFT block 424 may generate N parallel signals by performing an FFT algorithm. The P-to-S block 425 may convert the parallel signals into a sequence of modulation symbols. The channel decoding and demodulation block 426 may perform a demodulation operation on the modulation symbols and may restore data by performing a decoding operation on a result of the demodulation operation.

In FIGS. 4A and 4B, discrete Fourier transform (DFT) and inverse DFT (IDFT) may be used instead of FFT and IFFT. Each of the blocks (e.g., components) in FIGS. 4A and 4B may be implemented by at least one of hardware, software, or firmware. For example, some blocks in FIGS. 4A and 4B may be implemented by software, and other blocks may be implemented by hardware or a combination of hardware and software. In FIGS. 4A and 4B, one block may be subdivided into a plurality of blocks, a plurality of blocks may be integrated into one block, some blocks may be omitted, and blocks supporting other functions may be added.

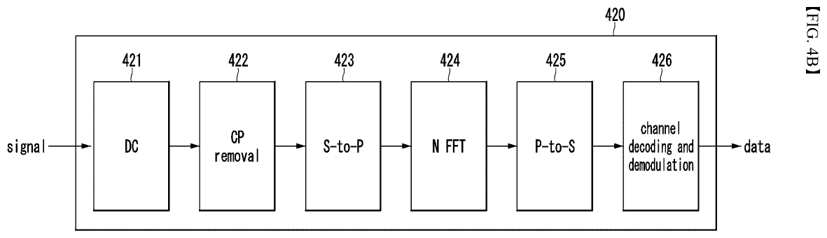

FIG. 5 is a conceptual diagram illustrating a first exemplary embodiment of a system frame in a communication system.

As shown in FIG. 5, time resources in the communication system may be divided on a frame basis. For example, system frames of the communication system may be configured continuously in the time domain. The length of the system frame may be 10 millisecond (ms). A system frame number (SFN) may be set to one of #0 to #1023. In this case, 1024 system frames may be repeated on the time domain of the communication system. For example, an SFN of a system frame after the system frame #1023 may be #0.

One system frame may include two half frames. The length of one half frame may be 5 ms. A half frame located at a starting region of the system frame may be referred to as ‘half frame #0’, and a half frame located at an ending region of the system frame may be referred to as ‘half frame #1’. One system frame may include 10 subframes. The length of one subframe may be 1 ms. 10 subframes within one system frame may be referred to as subframes #0-#9.

FIG. 6 is a conceptual diagram illustrating a first exemplary embodiment of a subframe in a communication system.

As shown in FIG. 6, one subframe may include n slots, and n may be a natural number. Accordingly, one subframe may consist of one or more slots.

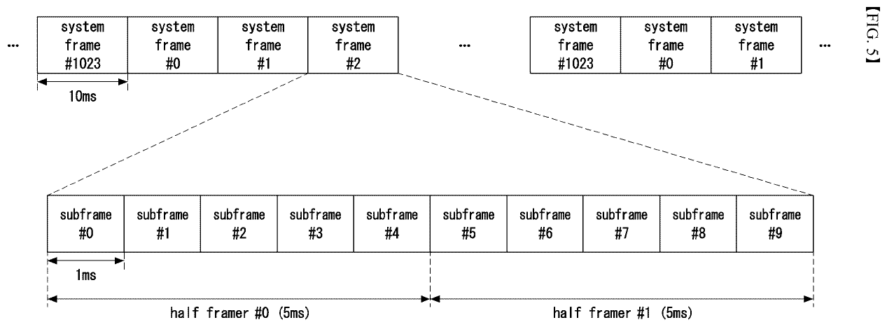

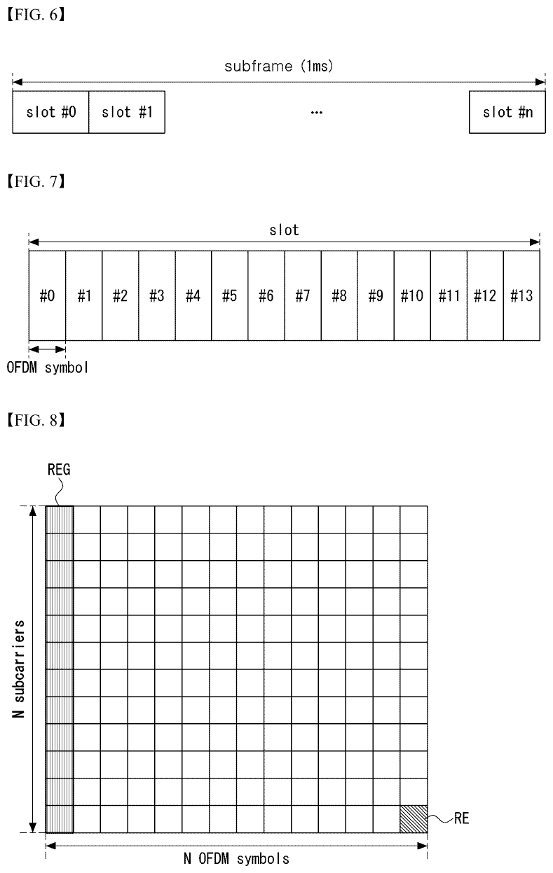

FIG. 7 is a conceptual diagram illustrating a first exemplary embodiment of a slot in a communication system.

As shown in FIG. 7, one slot may include one or more symbols. For example, one slot shown in FIG. 7 may include 14 symbols. The length of slot may vary according to the number of symbols included in a slot and the length of symbol. Alternatively, the length of slot may vary according to a numerology.

The numerology applied to physical signals and channels in a communication system may be variable. The numerology may be adjusted to meet various technical requirements of the communication system. In a communication system where a cyclic prefix (CP)-based OFDM waveform technology is applied, the numerology may include a subcarrier spacing and a CP length (or CP type). Table 1 may illustrate a first exemplary embodiment of a method for configuring numerologies for a CP-OFDM-based communication system. Depending on a frequency band in which the communication system operates, at least some of the numerologies in Table 1 may be supported. Additionally, the communication system may support numerologies not listed in Table 1.

TABLE 1

| | Subcarrier spacing | | | | | |
|---|---|---|---|---|---|---|
| | 15 | 30 | 60 | 120 | 240 | 480 |
| | kHz | kHz | kHz | kHz | kHz | kHz |
| OFDM symbol | 66.7 | 33.3 | 16.7 | 8.3 | 4.2 | 2.1 |
| length [μs] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

When a subcarrier spacing is 15 kHz (e.g., μ=0), the length of slot may be 1 ms. In this case, one system frame may include 10 slots. When a subcarrier spacing is 30 kHz (e.g., μ=1), the length of slot may be 0.5 ms. In this case, one system frame may include 20 slots.

When a subcarrier spacing is 60 kHz (e.g., μ=2), the length of slot may be 0.25 ms. In this case, one system frame may include 40 slots. When a subcarrier spacing is 120 kHz (e.g., μ=3), the length of slot may be 0.125 ms. In this case, one system frame may include 80 slots. When a subcarrier spacing is 240 kHz (e.g., μ=4), the length of slot may be 0.0625 ms. In this case, one system frame may include 160 slots.

The symbol may be configured as a downlink (DL) symbol, flexible (FL) symbol, or uplink (UL) symbol. A slot composed of only DL symbols may be referred to as a ‘DL slot’, a slot composed of only FL symbols may be referred to as a ‘FL slot’, and a slot composed of only UL symbols may be referred to as a ‘UL slot’.

A slot format may be semi-statically configured through higher-layer signaling (e.g., RRC signaling). Information indicating a semi-static slot format may be included in system information, and the semi-static slot format may be configured cell-specifically. Additionally, a semi-static slot format may be further configured for each terminal through terminal-specific higher-layer signaling (e.g., RRC signaling). Flexible symbols in the cell-specific slot format may be overridden to be downlink symbols or uplink symbols through terminal-specific higher-layer signaling. Furthermore, a slot format may be dynamically indicated through physical layer signaling (e.g., slot format indicator (SFI) included in DCI). The semi-statically configured slot format may be overridden by the dynamically indicated slot format. For example, flexible symbols configured semi-statically may be overridden to be downlink symbols or uplink symbols by the SFI.

Reference signals may include Channel State Information-Reference Signal (CSI-RS), Sounding Reference Signal (SRS), Demodulation-Reference Signal (DM-RS), and Phase Tracking-Reference Signal (PT-RS). Channels may include Physical Broadcast Channel (PBCH), Physical Downlink Control Channel (PDCCH), Physical Downlink Shared Channel (PDSCH), Physical Uplink Control Channel (PUCCH), PUSCH (Physical Uplink Shared Channel), PSCCH (Physical Sidelink Control Channel), and PSSCH (Physical Sidelink Shared Channel). In the present disclosure, a control channel may refer to PDCCH, PUCCH, or PSCCH, and a data channel may refer to PDSCH, PUSCH, or PSSCH.

FIG. 8 is a conceptual diagram illustrating a first exemplary embodiment of a time-frequency resource in a communication system.

As shown FIG. 8, a resource composed of one OFDM symbol on the time axis and one subcarrier on the frequency axis may be defined as a ‘resource element (RE)’. A resource composed of one OFDM symbol on the time axis and K subcarriers on the frequency axis may be defined as a ‘resource element group (REG)’. The REG may include K REs. The REG may be used as a basic unit of resource allocation in the frequency domain. K may be a natural number. For example, K may be 12. N may be a natural number. In the slot shown in FIG. 7, N may be 14. N OFDM symbols may be used as a basic unit of resource allocation in the time domain.

In the present disclosure, an RB may refer to a common RB (CRB). Alternatively, an RB may refer to a physical RB (PRB) or a virtual RB (VRB). In a communication system, a CRB may refer to an RB that constitutes a set of contiguous RBs (e.g., a common RB grid) based on a reference frequency (e.g., point A). A carrier and/or bandwidth part may be mapped onto the common RB grid. That is, a carrier and/or bandwidth part may be configured with CRB(s). The RBs or CRBs that constitute a bandwidth part may be referred to as PRBs, and a CRB index may be appropriately converted to a PRB index within the bandwidth part.

Downlink data may be transmitted through a PDSCH. A base station may transmit configuration information (e.g., scheduling information) of the PDSCH to a terminal through a PDCCH. The terminal may obtain the configuration information of the PDSCH by receiving the PDCCH (e.g., Downlink Control Information (DCI)). For example, the configuration information of the PDSCH may include a Modulation Coding Scheme (MCS) used for transmission/reception of the PDSCH, time resource information of the PDSCH, frequency resource information of the PDSCH, and feedback resource information for the PDSCH. The PDSCH may refer to a radio resource where the downlink data is transmitted and received. Alternatively, the PDSCH may refer to the downlink data itself. The PDCCH may refer to a radio resource where the downlink control information (e.g., DCI) is transmitted and received. Alternatively, the PDCCH may refer to the downlink control information itself.

The terminal may perform a monitoring operation for the PDCCH to receive the PDSCH transmitted from the base station. The base station may notify the terminal of configuration information for the PDCCH monitoring operation using a higher-layer message (e.g., Radio Resource Control (RRC) message). The configuration information for the PDCCH monitoring operation may include Control Resource Set (CORESET) information and search space information.

The CORESET information may include PDCCH DMRS information, PDCCH precoding information, and PDCCH occasion information, and the like. A PDCCH DMRS may be a DMRS used for demodulating a PDCCH. A PDCCH occasion refers to a region where a PDCCH may potentially exist, meaning it is a region where DCI can be transmitted. A PDCCH occasion may also be referred to as a PDCCH candidate. The PDCCH occasion information may include time resource information and frequency resource information for the PDCCH occasion. In the time domain, the length of the PDCCH occasion may be indicated in symbol units. In the frequency domain, the size of the PDCCH occasion can be indicated in RB units (e.g., in PRB units or CRB units).

The search space information may include a CORESET identifier (ID) associated with a search space, a periodicity of PDCCH monitoring, and/or an offset of PDCCH monitoring. The periodicity and offset of PDCCH monitoring may each be indicated in slot units. Additionally, the search space information may further include an index of a symbol where the PDCCH monitoring operation starts.

The base station may configure Bandwidth Part(s) (BWP(s)) for downlink communication. The BWP(s) may be configured differently for each terminal. The base station may notify the terminal of BWP configuration information using higher-layer signaling. The higher-layer signaling may refer to a transmission operation of system information and/or a transmission operation of RRC message(s). The number of BWPs configured for a single terminal may be one or more. The terminal may receive the BWP configuration information from the base station and identify the configured BWP(s) based on the received configuration information. When multiple BWPs are configured for downlink communication, the base station may activate one or more BWPs from among the multiple BWPs. The base station may transmit configuration information of the activated BWP(s) to the terminal using at least one of higher-layer signaling, Medium Access Control (MAC) Control Element (CE), or DCI. The base station may perform downlink communication using the activated BWP(s). The terminal may identify the activated BWP(s) by receiving the configuration information from the base station and perform downlink reception operations on the activated BWP(s).

Meanwhile, a communication system (e.g., NR communication system, 5G communication system, or 6G communication system) may support use scenarios such as enhanced Mobile BroadBand (eMBB), Ultra Reliable Low Latency Communication (URLLC), and massive Machine Type Communication (mMTC). The communication system (e.g., communication network) may support a transmission and reception point (TRP) technology (e.g., multi-TRP (mTRP) technology and/or single TRP (STRP) technology). The communication system supporting the TRP technology may be referred to as a TRP system (e.g., mTRP system and/or sTRP system). In the present disclosure, ‘TRP’ may have a meaning including ‘sTRP’ and/or ‘mTRP’, and ‘TRP’ may refer to ‘sTRP’ or ‘mTRP’ depending on a context. A TRP may refer to an antenna set, antenna group, and/or antenna array. A TRP may be associated with a CORESET and/or a beam (e.g., beam group).

The mTRP technology may fall under a category of MIMO technology. The mTRP may have characteristics (e.g., cell-level characteristics) of macro cells, small cells, pico cells, and/or femto cells. The mTRP may perform data transmission for a terminal. In a case where a channel (e.g., link) with a non-uniform channel condition exists due to an obstacle and/or interference, the mTRP may mitigate the effect caused by the obstacle and/or interference. The mTRP may improve a data transmission rate for a terminal located in a cell edge.

mTRP-based communication may be performed based on a coherent joint transmission (CJT) scheme or a non-coherent joint transmission (NCJT) scheme. In the CJT scheme, a base station may be aware of channel information between each TRP and a terminal and may perform a preprocessing operation for data based on the channel information. In this case, an overhead caused by a transmission procedure of the channel information may increase, and synchronization constraints among the TRPs may occur. In the NCJT scheme, a base station may not need to be aware of channel information between each TRP and a terminal. The mTRP may transmit data to the terminal without performing a preprocessing operation such as phase compensation. The complexity of the NCJT scheme may be lower than the complexity of the CJT scheme.

NCJT-based mTRP communication may be performed based on a single-DCI scheme or a multi-DCI scheme. In the single-DCI scheme, PDSCHs transmitted by mTRP may be scheduled by a single DCI. The single DCI may be transmitted by one TRP of the mTRP. In the multi-DCI scheme, a PDSCH transmitted by each TRP may be scheduled by a DCI transmitted by the corresponding TRP. For example, a first PDSCH transmitted by a first TRP may be scheduled by a first DCI transmitted by the first TRP, and a second PDSCH transmitted by a second TRP may be scheduled by a second DCI transmitted by the second TRP. In other words, a plurality of PDSCHs may be scheduled using a plurality of DCIs.

In the single SCI scheme, a terminal may expect to receive PDSCHs transmitted by different TRPs through different layers while using the same time and frequency resource. Alternatively, the terminal may expect to receive PDSCHs transmitted by different TRPs through different time resources (e.g., different time regions) while using the same frequency resource and the same layer. Alternatively, the terminal may expect to receive PDSCHs transmitted by different TRPs through different frequency resources (e.g., different frequency regions) while using the same time resource and the same layer.

In the multi-DCI scheme, PDSCH scheduling for each TRP may be performed by an individual DCI. PDSCHs scheduled by a plurality of DCIs may be fully overlapped or partially overlapped. Alternatively, PDSCHs scheduled by a plurality of DCIs may not be overlapped. In both the single-DCI scheme and the multi-DCI scheme, the DCI may include transmission configuration indicator (TCI) state information for PDSCH(s).

An indication/configuration of a TCI state for a terminal may be interpreted as an indication/configuration of a beam (e.g., a transmission beam and/or a reception beam). In other words, the TCI state may have a meaning corresponding to the beam. From the perspective of downlink (DL) communication, configuration of a TCI state may refer to configuration of a quasi-co-location (QCL). From the perspective of uplink (UL) communication, configuration of a TCI state may refer to configuration of a spatial filter. A unified TCI state may indicate (e.g., configure) a common beam regardless of DL communication and UL communication. Alternatively, a unified TCI state may indicate (e.g., configure) a common beam for each of DL communication and UL communication. The unified TCI may be referred to as ‘UTCI’.

To enhance the reliability and/or robustness of mTRP communication, improvements such as PDCCH enhancements may be applied. Deployment scenarios for PDCCH enhancement may be classified into a single frequency network (SFN) and a non-SFN.

In the SFN scheme, different TRPs or different panels may transmit the same PDCCH using the same resource (e.g., the same time resource, the same frequency resource, and/or the same spatial resource). In other words, all TRPs or all panels may transmit the PDCCH using the same DMRS configuration, the same DMRS position, and/or the same DMRS sequence. In this case, from the reception perspective for the TRPs or panels, TCI states may be implicitly configured differently. The above-described exemplary embodiment may be performed based on a plurality of TCI states of a CORESET. Synchronization constraints for an ideal backhaul or a near-ideal backhaul among the TRPs may exist.

In the NSFN scheme, PDCCHs generated by the respective TRPs may be multiplexed in the time domain and/or the frequency domain, and the multiplexed PDCCHs may be transmitted to the terminal. This scheme may be an mTRP-based PDCCH repetition scheme. In the NSFN scheme, the number of encoded bits equal to the number of bits delivered through one PDCCH generated in each TRP may be divided among the TRPs, and the TRP-specific bits (e.g., encoded bits) may be transmitted through a different PDCCH candidate for each TRP. This scheme may correspond to an sTRP-based PDCCH transmission scheme.

In the mTRP-based PDCCH repetition scheme, a PDCCH may be duplicated according to the number of TRPs, and the PDCCHs may be transmitted in the same search spaces (e.g., search spaces having the same index) within different search space sets, each having the same number of PDCCH candidates. In this case, the search space sets may exist within the same CORESET or within different CORESETs. Since one TCI state may be associated with each CORESET, when PDCCHs are transmitted from different search spaces within the same CORESET, only one TCI state for the PDCCHs transmitted from the different search spaces may be indicated (e.g., configured). In this case, the terminal may receive one PDCCH from one TRP at a specific time.

When the PDCCHs are transmitted from the same search spaces within different CORESETs, the terminal may implicitly expect to receive the PDCCH from STRP or mTRP depending on the number of TCI states (e.g., TCI states indicated or configured by the base station). In this case, a single PDCCH may be divided into as many PDCCHs as the number of TRPs, and the divided PDCCHs may be transmitted in different PDCCH candidates. In this case, an aggregation level and a combined aggregation level may be the same. In the above exemplary embodiment, the PDCCH candidates may be allocated to different CORESETs. A payload size for a combination of finally distributed PDCCHs may be the same as a payload size of a PDCCH transmitted from sTRP. Accordingly, in terms of decoding complexity, the sTRP-based PDCCH transmission scheme may be more advantageous than the mTRP-based PDCCH repetition scheme.

A terminal may perform mTRP communication or sTRP communication with a base station. The mTRP communication between the terminal and the base station may be performed via mTRP associated with the base station. The sTRP communication between the terminal and the base station may be performed via sTRP associated with the base station. The mTRP communication may be referred to as first TRP communication, and the sTRP communication may be referred to as second TRP communication. Alternatively, the mTRP communication may be referred to as second TRP communication, and the sTRP communication may be referred to as first TRP communication. The expression ‘A terminal performs first TRP communication with a base station’ may mean that the terminal performs mTRP communication or sTRP communication with the base station via one or more TRPs associated with the base station. The expression “A terminal performs second TRP communication with a base station” may mean that “the terminal performs sTRP communication or mTRP communication with the base station via one or more TRPs associated with the base station”.

In a communication system, a united TCI framework may be supported. A base station may transmit information of a pool (e.g., pool list) of TCI states to a terminal using RRC signaling. The terminal may receive the information of the pool (e.g., pool list) of TCI states through the RRC signaling of the base station. The base station may configure type information of TCI states for the terminal. The type information may indicate a joint DL/UL beam indication or a separate DL/UL beam indication. The joint DL/UL beam indication may be referred to as ‘joint indication’ or ‘joint type’. The separate DL/UL beam indication may be referred to as ‘separate indication’ or ‘separate type’.

When the joint type (e.g., joint indication) is configured, a TCI state (e.g., one TCI state) for DL and UL may be configured. In other words, a DL TCI state configuration and a UL TCI state configuration may be the same. The terminal may expect that a TCI state indicated by an information element included in PDSCH configuration information is applied to both DL (e.g., DL signal/channel) and UL (e.g., UL signal/channel). The term ‘signal/channel’ may refer to a signal and/or a channel. When the separate type (e.g., separate indication) is configured, TCI states for DL and UL, respectively, may be configured. In other words, a DL TCI state configuration may be distinguished from a UL TCI state configuration. The terminal may expect that a UL TCI state indicated by an information element included in UL BWP configuration information is applied to UL (e.g., UL signal/channel). A UL signal/channel may include PUSCH, PUCCH, and/or SRS.

After the pool (e.g., pool list) of TCI states is configured (e.g., indicated) by RRC signaling, the base station may indicate TCI state(s) (e.g., application of the TCI state(s)) using DCI (e.g., DCI signaling). Due to the constraint of the DCI size (e.g., bits of DCI fields), the base station may preferentially activate candidate TCI state(s) using MAC signaling (e.g., MAC CE signaling). In other words, candidate TCI states, up to a certain number (e.g., a maximum number) that can be indicated or configured through DCI, may be preferentially activated by a MAC CE.

For the activated candidate TCI state(s), DCI may include a codepoint corresponding to a single TCI state or two TCI states according to a TCI state type (e.g., joint type or separate type). When the joint type is configured, a codepoint corresponding to a single TCI state may be delivered by the DCI. When the separate type is configured, a codepoint corresponding to two TCI states may be delivered by the DCI. A unified TCI (e.g., unified TCI framework) designed for sTRP operation (e.g., sTRP communication) may be applied (e.g., extended) to mTRP operation (e.g., mTRP communication).

The unified TCI state framework may be configured (e.g., applied) to sTRP and mTRP operations. A switching operation (e.g., dynamic switching operation) between sTRP operation and mTRP operation may be supported. The switching operation between sTRP operation and mTRP operation may be referred to as a ‘TRP switching operation’. The TRP switching operation may refer to ‘switching operation from mTRP operation to sTRP operation’, ‘switching operation from sTRP operation to mTRP operation’, and/or ‘switching operation from a specific TRP operation to another TRP operation’. For configuration of a TCI state of a PDSCH, a TCI selection field may be introduced. DCI may include the TCI selection field. The TCI selection field may be used not only for configuration of a reception beam (e.g., TCI state) of the PDSCH in the terminal but also for a TRP switching operation (e.g., indication of the TRP switching operation). TRP switching operations may be required not only for PDSCH but also for other signals/channels. A TCI field included in DCI may be used for configuration of TCI state(s) and/or a TRP switching operation (e.g., indication of the TRP switching operation). In other words, the TCI field included in DCI may or may not be used for the TRP switching operation.

The base station may actively select (e.g., use) an sTRP operation or an mTRP operation according to a channel environment. In this case, the efficiency of resource usage may be improved. TRP switching operations may be required not only for PDSCH but also for other signals/channels (e.g., other DL signals/channels).

In a communication system, the TRP switching operation may be supported. The TRP switching operation may refer to a dynamic TRP switching operation. A base station may transmit an indication of the TRP switching operation to a terminal, and the indication of the TRP switching operation may be transmitted using at least one of an RRC message, a MAC CE, or a DCI. The terminal may receive the indication of the TRP switching operation from the base station. The base station and/or the terminal may perform the TRP switching operation based on the indication of the TRP switching operation. For example, the base station and/or the terminal may switch from mTRP communication to sTRP communication and may perform the sTRP communication. Alternatively, the base station and/or the terminal may switch from sTRP communication to mTRP communication and may perform the mTRP communication. The indication of the TRP switching operation may refer to a triggering command of the TRP switching operation.

When the TRP switching operation is indicated, a definition of a time of performing the TRP switching operation (e.g., application time) may be required. ‘Time’ may be interpreted as ‘duration’ or ‘time point’ depending on a context. As in a beam application time, an application time (e.g., physical time) for performing the TRP switching operation may be required. The TRP switching operation may be performed after it is confirmed that the indication of the TRP switching operation is received at the terminal. In this case, before the TRP switching operation is performed, a time for confirming the reception of the indication of the TRP switching operation may be required.

Operations of communication nodes (e.g., base station and/or terminal) may differ according to parameter(s) related to application of a unified TCI state and/or the application time of the TRP switching operation. In this case, a problem regarding a performance of the TRP switching operation may occur. A start time, an application duration, and/or an end time of the TRP switching operation may need to be defined.

A DCI may include a TCI selection field. The TCI selection field may be used to indicate a TCI state (e.g., TCI configuration) of a PDSCH. The DCI may include a TCI field and the TCI selection field. The TCI selection field may be configured independently of the TCI field. The TCI field may indicate a TCI codepoint indicating TCI states (e.g., information on the TCI states). The TCI selection field may be applied to a PDSCH scheduled by the DCI (e.g., PDCCH) including the TCI field. The TCI selection field may be used for indicating TCI state(s) related to PDSCH reception and/or the indication of the TRP switching operation.

The base station may actively select (e.g., use) sTRP communication or mTRP communication according to a channel environment. In this case, efficiency of resource usage may be improved. The TRP switching operation may be applied not only to PDSCH transmission but also to other channel transmissions. A channel may refer to a DL channel and/or a UL channel. A channel may be interpreted as ‘channel’, ‘signal’, or ‘channel and signal’ depending on a context. Each of a TCI and a TCI state may be interpreted as a unified TCI and a unified TCI state depending on a context.

The terminal may transmit a request for a TRP switching operation to the base station based on a state of a DL channel and/or a UL channel. The base station may receive the request for the TRP switching operation from the terminal. The base station may transmit an indication of the TRP switching operation to the terminal in consideration of the request of the terminal. Alternatively, the terminal may not transmit a request for a TRP switching operation to the base station, and the base station may transmit an indication of a TRP switching operation to the terminal without consideration of a request of the terminal. The terminal may receive the indication of the TRP switching operation from the base station and may perform the TRP switching operation based on the indication. The base station and/or the terminal may determine an application time point (e.g., application time) based on the indication of the TRP switching operation and may perform the TRP switching operation at the application time point. The application time (e.g., execution time) of the TRP switching operation may be defined as follows. The base station and/or the terminal may determine the application time of the TRP switching operation based on the following method(s) and may perform the TRP switching operation at the application time.

### Application Time of TRP Switching Operation

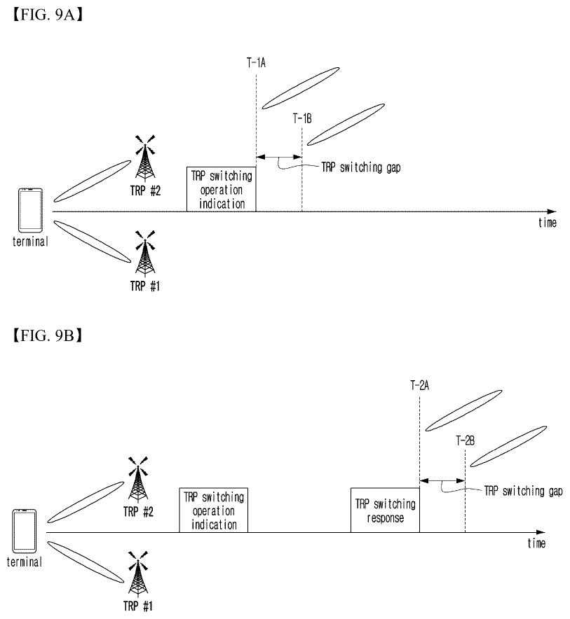

FIG. 9A is a timing diagram illustrating an application time of a TRP switching operation.

As shown in FIG. 9A, a terminal may perform communication via TRP #1 and TRP #2. In other words, the terminal may perform mTRP communication. TRP #1 and TRP #2 may be associated with a base station. The base station may transmit an indication of a TRP switching operation to the terminal through signaling. The indication of the TRP switching operation may be transmitted via one of TRP #1 or TRP #2. The terminal may receive the indication of the TRP switching operation from the base station.

When a time (e.g., a delay time or a required time) for application of the TRP switching operation is not required, the terminal may perform the TRP switching operation after receiving the indication of the TRP switching operation. In other words, the TRP switching operation may be performed immediately after the indication of the TRP switching operation is received. In this case, the TRP switching operation may be performed at a time T-1A. The time T-1A may correspond to a reception end time (e.g., reception end symbol) of the indication of the TRP switching operation. Alternatively, the time T-1A may correspond to a start symbol, an arbitrary symbol, or a last symbol within a slot (or subframe) in which the indication of the TRP switching operation is received. The arbitrary symbol may be configured between the terminal and the base station. For example, the base station may transmit information of the arbitrary symbol to the terminal through signaling. When the TRP switching operation is completed, communication between the terminal and the base station may be performed via switched TRP(s) (e.g., sTRP or mTRP).

A time for application of the TRP switching operation may be required. For example, due to a time for beam reconfiguration, a time for signaling processing, and a latency occurring in physical elements, the time for application of the TRP switching operation may be required. When the terminal performs mTRP communication using different beams (e.g., different reception beams and/or different transmission beams), the time for application of the TRP switching operation (e.g., the TRP switching operation from mTRP communication to sTRP communication) may be required. When TRP(s) (e.g., TRP(s) connected to the terminal) attempt to perform communication using different beams (e.g., different reception beams and/or different transmission beams), the time for application of the TRP switching operation may be required.

When the time for application of the TRP switching operation is required, the terminal may not be expected to perform communication (e.g., a reception operation and/or a transmission operation) during a TRP switching gap (e.g., a time gap for TRP switching) from the reception time of the indication of the TRP switching operation. In other words, the terminal may not perform communication in resources (e.g., time resources, frequency resources, and physical channels) corresponding to the TRP switching gap.

The TRP switching gap may be predefined in the technical specifications. In another method, the base station and/or the terminal may determine a TRP switching gap and may use the determined TRP switching gap. For example, the terminal may transmit UE capability information (e.g., UE capability report) including information on a time for application of a TRP switching operation to the base station. The time for application of a TRP switching operation may vary according to a UE capability (e.g., a capability of the terminal). The base station may receive the UE capability information from the terminal, may identify the time for application of a TRP switching operation included in the UE capability information, and may determine a TRP switching gap in consideration of the time for application of a TRP switching operation. Alternatively, the base station may determine a TRP switching gap without consideration of the UE capability information. The base station may transmit information on the TRP switching gap to the terminal through signaling. The terminal may receive the information on the TRP switching gap from the base station. The base station and/or the terminal may determine an application time of the TRP switching operation based on the indication of the TRP switching operation and the TRP switching gap.

The information on the TRP switching gap may be cell-common information (e.g., cell-specific information) or UE-specific information. The information on the TRP switching gap may be included in system information and/or an RRC message commonly applied within a cell. Alternatively, the information on the TRP switching gap may be included in a MAC CE and/or a DCI applied to a specific terminal. The TRP switching gap may be configured in units of symbols, slots, or a specific time (e.g., milliseconds (ms)). The TRP switching gap may be referred to as a TRP switching offset.

In the exemplary embodiment of FIG. 9A, when a time for application of the TRP switching operation is required, the terminal may perform the TRP switching operation after the TRP switching gap from the reception time of the indication of the TRP switching operation. In other words, the terminal may perform the TRP switching operation at a time T-1B. The base station may expect that the terminal performs the TRP switching operation after the TRP switching gap from the reception time of the indication of the TRP switching operation. The TRP switching gap may start from the reception end time (e.g., reception end symbol) of the indication of the TRP switching operation. Alternatively, the TRP switching gap may start from a start symbol, an arbitrary symbol, or a last symbol within a slot (or subframe) in which the indication of the TRP switching operation is received. The arbitrary symbol may be configured between the terminal and the base station. For example, the base station may transmit information on the arbitrary symbol to the terminal through signaling. When the TRP switching operation is completed, communication between the terminal and the base station may be performed via switched TRP(s) (e.g., sTRP or mTRP).

FIG. 9B is a timing diagram illustrating an application time of a TRP switching operation.

As shown in FIG. 9B, a terminal may perform communication via TRP #1 and TRP #2. In other words, the terminal may perform mTRP communication. TRP #1 and TRP #2 may be associated with a base station. The base station may transmit an indication of a TRP switching operation to the terminal through signaling. The indication of the TRP switching operation may be transmitted via one of TRP #1 or TRP #2. The terminal may receive the indication of the TRP switching operation from the base station. When the indication of the TRP switching operation is successfully received, the terminal may transmit a response to the indication (e.g., a TRP switching response) to the base station.

The TRP switching response may be a hybrid automatic repeat request (HARQ)-acknowledgement (ACK) for the indication of the TRP switching operation. The TRP switching response may be transmitted via at least one of TRP #1 or TRP #2. The TRP switching response may be transmitted on a PUCCH or a PUSCH. The base station may receive the TRP switching response from the terminal. When the TRP switching response is received from the terminal, the base station may determine that the indication of the TRP switching operation is successfully received at the terminal. The terminal may perform the TRP switching operation after transmitting the TRP switching response. The base station may perform the TRP switching operation after receiving the TRP switching response.

The indication of the TRP switching operation may not be successfully received at the terminal. For example, reception of the indication of the TRP switching operation may fail due to a channel environment. When it is configured that the TRP switching operation is performed after transmission and reception of the indication of the TRP switching operation, the terminal that does not receive the indication of the TRP switching operation may not perform the TRP switching operation, but the base station that transmits the indication of the TRP switching operation may expect that the terminal performs the TRP switching operation. In this case, the base station may perform the TRP switching operation after transmission of the indication of the TRP switching operation. In other words, the base station may indicate communication to switched TRP(s) (e.g., sTRP or mTRP). In the above situation, TRP communication (e.g., mTRP communication) performed by the terminal may be different from TRP communication (e.g., sTRP communication) performed by the base station, and in this case, communication between the terminal and the base station may fail. In order to prevent occurrence of the above problem, the TRP switching operation may be configured to be performed after transmission and reception of the TRP switching response.

When the time for application of the TRP switching operation is not required, the terminal may perform the TRP switching operation at a transmission time (e.g., a transmission end symbol) of the TRP switching response. In other words, the TRP switching operation may be performed immediately after transmission of the TRP switching response. Alternatively, the terminal may perform the TRP switching operation at a start symbol, an arbitrary symbol, or a last symbol within a slot (or a subframe) in which the TRP switching response is transmitted. The arbitrary symbol may be configured between the terminal and the base station. For example, the base station may transmit information on the arbitrary symbol to the terminal through signaling. When the time for application of the TRP switching operation is not required, the TRP switching operation may be performed at a time T-2A. In other words, the terminal and/or the base station may perform the TRP switching operation at the time T-2A and may perform communication via switched TRP(s) (e.g., sTRP or mTRP)

When the time for application of the TRP switching operation is required, the terminal may perform the TRP switching operation after a TRP switching gap from a transmission time (e.g., transmission end symbol) of the TRP switching response. Alternatively, the terminal may perform the TRP switching operation after the TRP switching gap from a start symbol, an arbitrary symbol, or a last symbol within a slot (or subframe) in which the TRP switching response is transmitted. The arbitrary symbol may be configured between the terminal and the base station. For example, the base station may transmit information on the arbitrary symbol to the terminal through signaling. The terminal and/or the base station may not be expected to perform communication during the TRP switching gap. When the time for application of the TRP switching operation is required, the TRP switching operation may be performed at a time T-2B. In other words, the terminal and/or the base station may perform the TRP switching operation at the time T-2B and may perform communication via switched TRP(s) (e.g., sTRP or mTRP).

The time for application of the TRP switching operation (e.g., TRP switching gap) may be applied to other exemplary embodiments (e.g., a time for application of an indication, a time for application of triggering) of the present disclosure.

### Types of TRP Switching Operation

TRP switching operation types may be classified as shown in Table 2 below.

TABLE 2

| | Description |
|---|---|
| Type 1 | The terminal may perform a TRP switching operation based on an |
| | indication of the TRP switching operation. The switched TRP(s) may be |
| | maintained until an additional indication is received. Alternatively, the |
| | switched TRP(s) may be maintained until a deactivation condition is |
| | satisfied. Deactivation may refer to deactivation or initialization of the |
| | TRP switching operation. |
| Type 2 | The terminal may perform a TRP switching operation based on an |
| | indication of the TRP switching operation. The switched TRP(s) may be |
| | maintained during a TRP switching duration. The TRP switching duration |
| | may be configured between the terminal and the base station. |
| Type 3 | The terminal may perform a TRP switching operation based on an |
| | indication of the TRP switching operation. A repetition duration, |
| | repetition period, and/or repetition count of the TRP switching operation |
| | may be configured at the terminal. Information on the repetition duration, |
| | repetition period, and/or repetition count of the TRP switching operation |
| | may be transmitted to the terminal together with the indication of the TRP |
| | switching operation. The switched TRP(s) may be maintained during the |
| | repetition duration. The TRP switching operation may be performed |
| | according to the repetition period. The TRP switching operation may be |
| | performed as many times as the repetition count. |

A TRP switching operation (e.g., an operation according to an indication of the TRP switching operation) may be performed based on the Type 1, Type 2, or Type 3. Regardless of the type(s) defined in Table 2, initialization of the TRP switching operation may be performed based on an activation command or a deactivation command for a unified TCI state. The initialization of the TRP switching operation may refer to applying indicated TCI state(s) (e.g., changed TCI state(s)) to the switched TRP(s) when a change of the TCI state(s) is indicated (e.g., configured) to the terminal.

The base station may determine a type of a TRP switching operation (e.g., Type 1, Type 2, or Type 3) and may transmit information on the type of the TRP switching operation to the terminal through signaling (e.g., RRC signaling, MAC signaling, and/or PHY signaling). The terminal may receive the information on the type of the TRP switching operation from the base station. In another method, the terminal may transmit information on supported type(s) among the types of TRP switching operation to the base station. The information on the supported type(s) may be included in UE capability information (e.g., UE capability report). In other words, the terminal may transmit information indicating whether a type of TRP switching operation is supported to the base station. The base station may receive information on the supported type(s) (e.g., information indicating whether a type of TRP switching operation is supported) from the terminal and may determine a type of the TRP switching operation in consideration of the information. The base station may transmit information on the type of the TRP switching operation to the terminal through signaling (e.g., RRC signaling, MAC signaling, and/or PHY signaling). The terminal may receive information on the type of the TRP switching operation from the base station.

The terminal may transmit preference values for parameters related to the type(s) of the TRP switching operation (e.g., TRP switching duration, repetition duration of the TRP switching operation, repetition period of the TRP switching operation, repetition count of the TRP switching operation) to the base station. The base station may receive the preference values from the terminal and may determine parameters related to the type(s) of the TRP switching operation in consideration of the preference values. The base station may transmit the determined parameters to the terminal through signaling. The determined parameters may be transmitted together with information on the type associated with the determined parameters. The terminal may receive the determined parameters from the base station.

### Type 1 of TRP Switching Operation

A base station may transmit a first indication (e.g., triggering command) of a TRP switching operation to a terminal. The terminal may receive the first indication of the TRP switching operation from the base station. The base station and/or the terminal may perform the TRP switching operation based on the first indication of the TRP switching operation. Communication between the base station and the terminal may be performed via switched TRP(s) (e.g., sTRP or mTRP). Until an additional indication is transmitted and received, communication between the base station and the terminal may be performed via the switched TRP(s) (e.g., sTRP or mTRP).

The base station may transmit a second indication of a TRP switching operation to the terminal. The second indication of the TRP switching operation may be distinguished from the first indication of the TRP switching operation. When the second indication of the TRP switching operation is received, the terminal may terminate communication via the switched TRP(s) based on the first indication of the TRP switching operation. The terminal may perform the TRP switching operation based on the second indication of the TRP switching operation and may perform communication based on switched TRP(s). In other words, communication between the base station and the terminal may be performed via the switched TRP(s) (e.g., sTRP or mTRP) based on the second indication of the TRP switching operation.

For another example, the base station may transmit TCI state change information (e.g., update information) to the terminal. The terminal may receive the TCI state change information from the base station. When the TCI state change information is received, the terminal may terminate communication via the switched TRP(s) based on the indication of the TRP switching operation. When the TCI state change information is transmitted, the base station may determine that the communication via the switched TRP(s) based on the indication of the TRP switching operation is terminated. In other words, the TRP switching operation may be initialized. The update of the TCI state may refer to change of the TCI state(s) used for configuring beams of the terminal (e.g., configuration of reception beams and/or transmission beams). Since the update of the TCI state means that a channel state is changed, communication based on the indication of the TRP switching operation may be terminated.

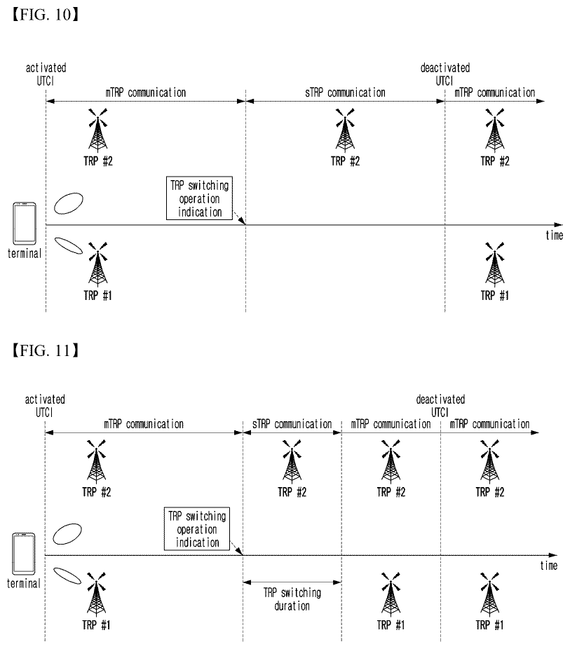

FIG. 10 is a timing diagram illustrating exemplary embodiments of a communication method based on Type 1 of TRP switching operation.

As shown in FIG. 10, a base station may transmit a unified TCI (UTCI) activation indication to a terminal, and the terminal may receive the UTCI activation indication from the base station. Communication between the base station and the terminal may be performed based on the activated UTCI. For example, the terminal may perform communication via TRP #1 and TRP #2. In other words, the terminal may perform mTRP communication. TRP #1 and TRP #2 may be associated with the base station. The base station may transmit an indication of a TRP switching operation to the terminal through signaling. The indication of the TRP switching operation may be transmitted via one of TRP #1 or TRP #2. The terminal may receive the indication of the TRP switching operation from the base station. The base station and/or the terminal may perform the TRP switching operation based on the indication of the TRP switching operation. Communication between the base station and the terminal may be performed via switched TRP(s) (e.g., TRP #2).

When Type 1 of the TRP switching operation is configured at the terminal and/or the base station, communication between the base station and the terminal may be performed via the switched TRP(s) (e.g., TRP #2) until an additional indication is received. The base station may transmit a UTCI deactivation indication to the terminal. The terminal may receive the UTCI deactivation indication from the base station. The TCI state of the terminal may be updated (e.g., changed) based on the UTCI deactivation indication, and the terminal may perform communication based on the updated TCI state. Even when an indication (e.g., configuration) of release of the TCI switching operation is not transmitted to the terminal, the terminal may perform communication based on the updated TCI state. Therefore, communication based on the indication of the TCI switching operation may be terminated. In other words, the TCI switching operation may be initialized. After transmission and reception of the UTCI deactivation indication, communication between the base station and the terminal may be performed via the TRP(s) before switching (e.g., TRP #1 and TRP #2).

Even when TCI state configuration for one TRP exists, the TRP may be switched (e.g., changed). For example, one TRP may be switched to another TRP. In this case, the base station and/or the terminal may expect that sTRP communication is performed. The update of the TCI state may be performed based on at least one of an activation command (e.g., activation MAC CE), a deactivation command (e.g., deactivation MAC CE), or a TCI indication (e.g., TCI field included in DCI).

In another method, the update of the TCI state(s) may not trigger execution of a TRP switching operation. In other words, even when the TCI state(s) are updated, communication between the base station and the terminal may be performed via the switched TRP(s). Regardless of whether the TCI state(s) are updated, the terminal may perform communication based on the previous indication of the TRP switching operation until an additional indication of a TRP switching operation is received. The previous TRP switching operation may not be initialized until an additional indication of a TRP switching operation is received.

The update of the TCI state may be applied to a TRP that is not switched. For example, when communication based on TRP #1 and TRP #2 is switched to communication based on TRP #2 based on an indication of a TRP switching operation, the update of the TCI state may be applied to TRP #2. The update of the TCI state may not be applied to TRP #1.

### Type 2 of TRP Switching Operation

A base station may transmit an indication (e.g., triggering command) of a TRP switching operation and information on a TRP switching duration to a terminal. The indication of the TRP switching operation and/or the information on the TRP switching duration may be transmitted to the terminal through signaling (e.g., RRC signaling, MAC signaling, and/or PHY signaling). The terminal may receive the indication of the TRP switching operation and the information on the TRP switching duration from the base station. The base station and/or the terminal may perform the TRP switching operation based on the indication of the TRP switching operation. The base station and/or the terminal may perform communication based on switched TRP(s) (e.g., STRP or mTRP) during the TRP switching duration.

The TRP switching duration may start at a reception end time (e.g., reception end symbol) of the indication of the TRP switching operation or a time after a TRP switching gap from the reception end time. Alternatively, the TRP switching duration may start at a start symbol, an arbitrary symbol, or a last symbol within a slot (or subframe) in which the indication of the TRP switching operation is received or a time after the TRP switching gap from the start symbol, the arbitrary symbol, or the last symbol.

In Type 2 of TRP switching operation, a signaling operation for deactivation of the TRP switching operation may not be required. Type 2 of TRP switching operation may be used when a channel (e.g., channel state) can be predicted (e.g., estimated). The indication of the TRP switching operation and the information on the TRP switching duration may be transmitted through the same signaling message. Alternatively, the indication of the TRP switching operation and the information on the TRP switching duration may be transmitted through different signaling messages. The information on the TRP switching duration may be included in system information and/or an RRC message. The TRP switching duration may be configured in units of symbols, slots, or time (e.g., ms).

The base station and/or the terminal may perform communication based on switched TRP(s) during the TRP switching duration and may perform communication based on TRP(s) before switching after an end time of the TRP switching duration. For example, the base station and/or the terminal may perform mTRP communication during the TRP switching duration and may perform sTRP communication after the end time of the TRP switching duration. Alternatively, the base station and/or the terminal may perform sTRP communication during the TRP switching duration and may perform mTRP communication after the end time of the TRP switching duration.

FIG. 11 is a timing diagram illustrating exemplary embodiments of a communication method based on Type 2 of TRP switching operation.

As shown in FIG. 11, a base station may transmit a UTCI activation indication to a terminal, and the terminal may receive the UTCI activation indication from the base station. Communication between the base station and the terminal may be performed based on the activated UTCI. For example, the terminal may perform communication via TRP #1 and TRP #2. In other words, the terminal may perform mTRP communication. TRP #1 and TRP #2 may be associated with the base station. The base station may transmit an indication of a TRP switching operation and information on a TRP switching duration to the terminal through signaling. The indication of the TRP switching operation and the information on the TRP switching duration may be transmitted via one of TRP #1 or TRP #2. The terminal may receive the indication of the TRP switching operation and the information on the TRP switching duration from the base station. The base station and/or the terminal may perform the TRP switching operation based on the indication of the TRP switching operation. Communication between the base station and the terminal may be performed via switched TRP(s) (e.g., TRP #2). Communication based on the switched TRP(s) (e.g., TRP #2) may be performed during the TRP switching duration.

After termination of the TRP switching duration, the base station and/or the terminal may perform communication based on the TRP(s) before switching (e.g., TRP #1 and TRP #2). In other words, the base station and/or the terminal may perform mTRP communication after termination of the TRP switching duration. After termination of the TRP switching duration, TCI state(s) for the mTRP before the TRP switching duration may be applied in the mTRP communication.

The base station may transmit a UTCI deactivation indication to the terminal. The UTCI deactivation indication may be transmitted after termination of the TRP switching duration. The terminal may receive the UTCI deactivation indication from the base station. When an update indication of TCI state(s) (e.g., UTCI activation indication or UTCI deactivation indication) is received, the terminal may change the TCI state(s) based on the update indication. The terminal may perform mTRP communication based on the changed TCI state(s). When the update indication of the TCI state(s) indicates update of a single TCI state (e.g., when the update indication of the TCI state(s) indicates a codepoint for a single TCI state), the terminal may update a TCI state for one TRP among the mTRP (e.g., two TRPs) and may maintain a TCI state for the remaining TRP among the mTRP. In other words, the TCI state for the remaining TRP among the mTRP may not be updated. The terminal may expect that the mTRP communication is performed in the situation.

### Type 3 of TRP Switching Operation

A base station may transmit an indication (e.g., triggering command) of a TRP switching operation and repetition configuration information to a terminal. The repetition configuration information may include at least one of information on a repetition duration of the TRP switching operation, information on a repetition period of the TRP switching operation, or information on a repetition count of the TRP switching operation. The repetition duration of the TRP switching operation may correspond to the TRP switching duration in Type 1 of TRP switching operation. The indication of the TRP switching operation and/or the repetition configuration information may be transmitted to the terminal through signaling (e.g., RRC signaling, MAC signaling, and/or PHY signaling). The terminal may receive the indication of the TRP switching operation and the repetition configuration information from the base station. The base station and/or the terminal may perform the TRP switching operation based on the indication of the TRP switching operation. The switched TRP(s) (e.g., sTRP or mTRP) may be maintained during the repetition duration. For example, communication based on the switched TRP(s) may be performed during the repetition duration. The TRP switching operation may be performed according to the repetition period. The TRP switching operation may be performed as many times as the repetition count.

Type 3 of TRP switching operation may be used when a channel (e.g., channel state) can be predicted (e.g., estimated). According to Type 3 of TRP switching operation, signaling overhead for the TRP switching operation may be reduced. Each of the repetition duration and the repetition period of the TRP switching operation may be configured in units of symbols, slots, or time (e.g., ms). The repetition count of the TRP switching operation may be configured to be at least n. n may be a natural number.

The repetition duration may be configured according to the repetition period. The repetition duration may be configured as many times as the repetition count. The TRP switching operation may be performed for each repetition duration. For example, the TRP switching operation may be performed at a start time of each repetition duration. After an end time of the repetition duration, the TRP switching operation may be initialized. In other words, after the end time of the repetition duration, communication based on the TRP(s) before switching may be performed. Communication based on the TRP(s) before switching may be performed during a duration from the end time of the repetition duration to a start time of a next repetition duration.

The base station may transmit an update indication of TCI state(s) to the terminal. The update indication of the TCI state(s) may be received before an end time of a repetition duration. In this case, even before the end time of the repetition duration, the TRP switching operation may be initialized. In other words, when the update indication of the TCI state(s) is received, the repetition duration may be terminated early.

In another method, when the update indication of the TCI state(s) is received before the end time of the repetition duration, the update indication may be applied to the TRP(s) that are not switched, and the update indication may not be applied to the switched TRP(s). The terminal may expect that mTRP communication is performed in the above situation. For example, in the exemplary embodiment of FIG. 11, when the TRP switching duration corresponds to the repetition duration, the update indication of the TCI state(s) may be applied to TRP #2 but not to TRP #1.

Operations of a Base Station and/or a Terminal when TCI State(s) are Updated after a TRP Switching Operation is Performed

A base station may transmit, to a terminal, an indication of a TRP switching operation according to Type 1, Type 2, or Type 3. The terminal may receive the indication of the TRP switching operation from the base station and may perform the TRP switching operation based on the indication. The base station and/or the terminal may perform communication based on switched TRP(s). After the TRP switching operation is performed, the base station may transmit, to the terminal, an update indication of TCI state(s). The terminal may receive the update indication of the TCI state(s) from the base station.

The update indication of the TCI state(s) may refer to configuration of a TCI state pool, activation of a TCI state pool, and/or indication of TCI state(s). The configuration of the TCI state pool may be based on RRC signaling. The activation of the TCI state pool may be based on a MAC CE. The indication of the TCI state(s) may be based on a MAC CE and/or DCI. The indication of the TCI state(s) may be an indication of a single TCI state or an indication of a TCI state set. The TCI state set may be a TCI state set for the separate type.

After the TRP switching operation is performed, the terminal may receive, from the base station, the update indication of the TCI state(s). In this case, the terminal and/or the base station may operate as follows.

When the indication of the TRP switching operation according to Type 2 or Type 3 is received, the terminal may expect that the type of the TRP switching operation changes from Type 2 or Type 3 to Type 1 until an additional indication of a TRP switching operation is received. When the indication of the TRP switching operation is received through a DCI, the terminal may reconfigure beams (e.g., transmission beams and/or reception beams) based on TCI state(s) associated with a codepoint indicated by a field (e.g., TCI field) included in the DCI.

However, since signaling design of higher layers for TCI state configuration of mTRP is not completed, the terminal may reconfigure the TCI state(s) as follows according to the indication of the TCI state(s). The base station may configure, for the terminal, TCI state(s) up to a maximum number of TRPs supported by the terminal. The method may be referred to as Method #1. The base station may signal, to the terminal, information on changed TCI state(s) in consideration of signaling overhead. The method may be referred to as Method #2. In Method #2, the information on the changed TCI state(s) may be signaled in a variable manner.

For example, the separate type for 4 TRPs may be configured, and TCI state(s) for TRP #2 and TRP #3 may be changed. 4 TRPs may mean four TRPs. In the above situation, according to Method #1, TCI state information (e.g., TCI state configuration) that the base station signals to the terminal may be [(-,-), (TCI #3, TCI #2), (TCI #5, TCI #4), (-,-)]. ‘-’ may refer to zero padding or a meaningless value. In the above situation, according to Method #2, TCI state information (e.g., TCI state configuration) that the base station signals to the terminal may be [(TCI #3, TCI #2), (TCI #5, TCI #4)]. Among TCI states according to a TCI codeword within [(-,-), (TCI #3, TCI #2), (TCI #5, TCI #4), (-,-)], a TCI state having a lowest index may be (-,-). Among TCI states according to a TCI codeword within [(TCI #3, TCI #2), (TCI #5, TCI #4)], a TCI state having a lowest index may be (TCI #3, TCI #2).

Configuration of N TRPs among M TRPs may exist. M TRPs may mean M TRPs. N TRPs may mean N TRPs. Each of M and N may be a natural number equal to or greater than 1. M may be greater than N. TCI states for the M TRPs may be updated in order as TCI state(s) having a lowest index or a highest index among TCI states according to a TCI codeword. The terminal may expect that TCI state(s) of (M-N) TRPs (e.g., (M-N) TRPs that are not mapped) are maintained as TCI state(s) before updating of the TCI state(s). For example, when a joint type is indicated to the terminal, a TRP switching operation to sTRP (e.g., TCI #5) is indicated to the terminal, and an update indication of TCI state(s) of the base station is (TCI #3, TCI #2), the terminal may perform TCI state update “TCI #5→TCI #3”.

In another example, when the separate type is indicated to the terminal, a TRP switching operation to sTRP (e.g., TCI #5) is indicated to the terminal, and an update indication of TCI state(s) of the base station is [(TCI #2, TCI #1), (TCI #4, TCI #3)], the terminal may perform TCI state update “TCI #5→TCI #2” for DL, and the terminal may perform TCI state update “TCI #5→TCI #1” for UL. The terminal may ignore (TCI #4, TCI #3), which is an update indication of the TCI state(s).

In yet another example, when the joint type is indicated to the terminal, a TRP switching operation to 2 TRPs (e.g., [(TCI #2), (TCI #3)]) is indicated to the terminal, and an update indication of TCI state(s) of the base station is (TCI #4), the terminal may perform TCI state update “TCI #2→TCI #4”, and the terminal may maintain TCI #3. In this case, the terminal may expect that communication of 2 TRPs based on [(TCI #4), (TCI #3)] is performed.

### Change of a TRP Switching Operation According to a Beam Application Time

An indication for a unified TCI state (e.g., unified TCI state information) may be transmitted to a terminal through a DCI or a MAC CE. In this case, the terminal may update an indicated TCI (e.g., configured TCI) after a beam application time. The TRP switching operation may be introduced for a unified TCI framework. When an indication of the TRP switching operation occurs before the beam application time, the terminal and/or the base station may expect that the TRP switching operation is performed after the beam application time. In other words, a start time of the TRP switching operation may be delayed to after the beam application time.

When the TRP switching operation starts before the beam application time, the terminal may perform the TRP switching operation without updating of the TCI state. The terminal may reconfigure the TCI state(s) after the beam application time. In this case, a number of TRPs used for communication between the terminal and the base station may be based on the indication of the TRP switching operation. For example, even when a TCI state indication includes TCI state(s) for mTRP, when the TRP switching operation from mTRP to sTRP is performed before the beam application time, the terminal may perform updating for TCI state(s) having a lowest index among TCI states according to a TCI codeword and may perform sTRP communication based on the updated TCI state(s). Unlike the above operation, after the beam application time, the TRP switching operation and/or a TCI updating operation may be performed based on the TCI state indication.

According to exemplary embodiments of the present disclosure, the base station and/or the terminal may perform a TRP switching operation based on an indication of the TRP switching operation and may perform communication via mTRP or sTRP. The exemplary embodiments of the present disclosure may be applied to a unified TCI framework and/or a general TCI framework. The exemplary embodiments of the present disclosure may be applied to mTRP dynamic switching and/or sTRP dynamic switching. The exemplary embodiments of the present disclosure may be applied to a licensed band and/or an unlicensed band.

The exemplary embodiments of the present disclosure may be applied not only to mTRP communication based on a single DCI but also to mTRP communication based on multiple DCIs. In the present disclosure, TRPs may be distinguished by TCI state(s) that are indicated (e.g., configured) to the terminal. In other words, the terminal may implicitly distinguish TRPs based on the TCI state(s). TRP change may be regarded as the same as change of the TCI state(s).

A panel switching operation of the terminal, an antenna element (AE) switching operation, and/or an AE group switching operation may be performed identically or similarly to the exemplary embodiments of the present disclosure (e.g., the TRP switching operation). In other words, the exemplary embodiments of the present disclosure may be applied to the panel switching operation of the terminal, the AE switching operation, and/or the AE group switching operation.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
performing a first transmission and reception point (TRP) communication with a base station;
receiving a first indication of a TRP switching operation from the base station;
determining an application time of the TRP switching operation based on the first indication;
performing the TRP switching operation from the first TRP communication to a second TRP communication at the application time; and
performing the second TRP communication with the base station,
wherein when the first TRP communication is multiple-TRP (mTRP) communication, the second TRP communication is single-TRP (STRP) communication, and when the first TRP communication is sTRP communication, the second TRP communication is mTRP communication.

2. The method of claim 1, further comprising receiving information on a TRP switching gap from the base station,
wherein the application time is after the TRP switching gap from a reception time of the first indication.

3. The method of claim 1, wherein the application time is after the UE transmits a response to the first indication to the base station.

4. The method of claim 1, wherein the second TRP communication after performing the TRP switching operation is performed until reception of a second indication of a TRP switching operation or a transmission configuration indicator (TCI) state update indication.

5. The method of claim 1, further comprising receiving information on a TRP switching duration from the base station,
wherein the second TRP communication after performing the TRP switching operation is performed during the TRP switching duration.

6. The method of claim 1, further comprising receiving repetition configuration information for the TRP switching operation from the base station,
wherein the second TRP communication after performing the TRP switching operation is performed during a repetition duration indicated by the repetition configuration information.

7. The method of claim 1, further comprising:
receiving a TCI state update indication from the base station; and
updating TCI state(s) for one or more TRPs performing the second TRP communication,
wherein TCI state(s) for remaining TRPs among a plurality of TRPs performing the first TRP communication, except the one or more TRPs, are not updated.

8. The method of claim 1, further comprising receiving TCI state information from the base station,
wherein the application time is after a beam application time for the TCI state information.

9. A method of a base station, comprising:
performing a first transmission and reception point (TRP) communication with a user equipment (UE);
transmitting a first indication of a TRP switching operation to the UE;
determining an application time of the TRP switching operation based on the first indication;
performing the TRP switching operation from the first TRP communication to a second TRP communication at the application time; and
performing the second TRP communication with the UE,
wherein when the first TRP communication is multiple-TRP (mTRP) communication, the second TRP communication is single-TRP (STRP) communication, and when the first TRP communication is sTRP communication, the second TRP communication is mTRP communication.

10. The method of claim 9, further comprising transmitting information on a TRP switching gap to the UE,
wherein the application time is after the TRP switching gap from a transmission time of the first indication.

11. The method of claim 9, wherein the application time is after the base station receives a response to the first indication from the UE.

12. The method of claim 9, wherein the second TRP communication after performing the TRP switching operation is performed until transmission of a second indication of a TRP switching operation or a transmission configuration indicator (TCI) state update indication.

13. The method of claim 9, further comprising transmitting information on a TRP switching duration to the UE,
wherein the second TRP communication after performing the TRP switching operation is performed during the TRP switching duration.

14. The method of claim 9, further comprising transmitting repetition configuration information for the TRP switching operation to the UE,
wherein the second TRP communication after performing the TRP switching operation is performed during a repetition duration indicated by the repetition configuration information.

15. The method of claim 9, further comprising transmitting TCI state information to the UE,
wherein the application time is after a beam application time for the TCI state information.

16. A user equipment (UE) comprising at least one processor, wherein the at least one processor causes the UE to perform:
performing a first transmission and reception point (TRP) communication with a base station;
receiving a first indication of a TRP switching operation from the base station;
determining an application time of the TRP switching operation based on the first indication;
performing the TRP switching operation from the first TRP communication to a second TRP communication at the application time; and
performing the second TRP communication with the base station,
wherein when the first TRP communication is multiple-TRP (mTRP) communication, the second TRP communication is single-TRP (sTRP) communication, and when the first TRP communication is sTRP communication, the second TRP communication is mTRP communication.

17. The UE of claim 16, wherein the at least one processor further causes the UE to perform: receiving information on a TRP switching gap from the base station,
wherein the application time is after the TRP switching gap from a reception time of the first indication.

18. The UE of claim 16, wherein the second TRP communication after performing the TRP switching operation is performed until reception of a second indication of a TRP switching operation or a transmission configuration indicator (TCI) state update indication.

19. The UE of claim 16, wherein the at least one processor further causes the UE to perform: receiving information on a TRP switching duration from the base station,
wherein the second TRP communication after performing the TRP switching operation is performed during the TRP switching duration.

20. The UE of claim 16, wherein the at least one processor further causes the UE to perform: receiving repetition configuration information for the TRP switching operation from the base station,
wherein the second TRP communication after performing the TRP switching operation is performed during a repetition duration indicated by the repetition configuration information.
